(19) United States
(12) Patent Application Publication
(10) Pub. No.: US 2018/0102688 A1
(43) Pub. Date: Apr. 12, 2018

(54) UNIVERSAL PERMANENT MAGNET SYNCHRONOUS MOTOR FOR HIGH VOLUME LOW SPEED FANS

(71) Applicant: RAKESH K. DHAWAN, ASHBURN, VA (US)

(72) Inventor: RAKESH K. DHAWAN, ASHBURN, VA (US)

(21) Appl. No.: 15/718,528

(22) Filed: Sep. 28, 2017

Related U.S. Application Data
(60) Provisional application No. 62/405,883, filed on Oct. 8, 2016.

(51) Int. Cl. H02K 7/14; H02K 1/27; H02K 1/28; H02K 5/10; H02K 7/08; H02K 9/19; H02K 11/33; H02K 21/22; H02K 3/18; H02K 5/16; F04D 25/06; F04D 29/70; F04D 27/00; F04D 25/08

(52) U.S. Cl. CPC H02K 7/14; H02K 1/2786; H02K 1/28; H02K 5/10; H02K 7/086; H02K 9/19; F04D 25/088; H02K 21/22; H02K 3/18; H02K 5/165; F04D 25/064; F04D 29/703; F04D 27/004; H02K 11/33

(57) ABSTRACT

Disclosed is a brushless gearless electric motor configured to accommodate plurality of fan blades. The brushless gearless electric motor is configured to provide low cogging and high torque in an electric fan. The brushless gearless electric motor includes a rotor, a stator, an axle, a bearing and a frame structure. The rotor rotates about an axis. Further, the rotor receives the plurality of fan blades. The stator is operable to rotate the rotor. The stator includes a bottom surface and a top surface. The rotor is configured to cover the bottom surface of the stator such that the top surface of the stator remains open to reduce overall weight. The axle aligns the stator with the rotor. The axle centers the rotor. The bearing is positioned around the center of the axle to facilitate relative motion between the stator and the rotor. The frame structure is configured on the top surface of the stator to facilitate attachment to a fixed support. Further, the axle includes a flange and a rod extending from the flange towards the rotor. The electric motor further includes a jam nut and a lock nut. The jam nut is positioned below the bearing and further the jam nut pressurizes the bearing against the flange. The lock nut sandwiches the bearing between the flange and the jam nut.

### CROSS REFERENCE TO RELATED APPLICATION

This application claims priority to U.S. Provisional Application No. 62/405,883 filed on Oct. 8, 2016, the entireties of which are incorporated herein by reference.

### BACKGROUND OF THE INVENTION

### 1. Field of the Invention

The present invention generally relates to an electric motor used for high volume low speed industrial fans (hereinafter referred as HVLS fans), and more particularly relates to a brushless gearless electric motor configured to directly adapt to the blades of a fan.

### 2. Description of Related Art

A high-volume low-speed (HVLS) fan is jumbo ceiling fan with a huge diameter. Because of their large diameter, HVLS fans move slowly. Fast rotation of these fans requires a lot of energy with little benefit. High volume low speed (HVLS) fans normally come with 2 to 8 blades and range from 6-ft to 24-ft in diameter.

The blades are attached horizontally from a hub mounted on a motor shaft. The HVLS fans operate at speeds from 50 to 250 rpm. Power delivered by fans rises to the cubic power of the diameter. To limit the power and maintain air flow, the speed is progressively reduced for larger diameters. Normally based on the number of blades and blade design, most fans are rated below 1.5 hp (1125 W).

Electric machines such as HVLS fans are designed and controlled (operated) using various well known engineering and control principles. Electric machines typically comprise a moveable portion (often referred to as a rotor), a stationary portion (often referred to as a stator) and a shaft assembly (containing axle, bearing and bearing mounting area).

A conventional rotor can be formed using techniques well known in the art. Two conventional rotor designs include a conductive wire cage rotor, such as for example, a rotor for an AC induction motor and a plurality of permanent magnets formed into a rotor, such as for example, a rotor for a brushless AC synchronous permanent magnet motor. Generally rotors include a rotating body, magnets and a back iron.

A conventional stator comprises a plurality of elements which are often referred to as stator poles. A conventional stator can be formed using techniques well known in the art. The end of the stator pole is often referred to as the pole face. Generally, stator includes a lamination stack, windings, stator plates and a shaft.

A conventional electric machine is operated by a machine controller. Conventional controllers are designed and operated using engineering and control principles well known in the art. Conventionally the machine winding is electrically connected to the controller using well known designs and techniques. The controller is also electrically connected to a power supply and a user input. The controller allows the winding to be selectively energized from the power supply.

The electric current travels from the power supply to the winding in a controlled direction and amount. As the electric current moves around the winding of the stator pole, an electro-magnetic field is generated in accordance with well known engineering principles. A temporary electro-magnetic field is generated at the stator pole face.

Improved controls, electronic hardware, digital signal processors (computers), and software have allowed electric machines to operate more efficiently, for example by the use of electronically controlled pulse width activation of the windings. These conventional techniques allow flexible control and efficient operation of the machine. Typical control techniques include controlling the shape, phase relationship, and amount of electric current from the power supply.

Some exemplary prior art electric machines used for industrial fans use direct drive transverse flux motors or induction motors with gears. However, a geared motor is heavy, inefficient, noisy and expensive. Further, conventional electric motors have two rotor covers with embedded bearings for covering the top and bottom surface of the stator.

Thus conventional electric motors with dual covers and bearings are not suitable for HVLS fans because they require extremely large bearings, liquid cooling, and exhibit an inability to handle torsional stresses as well as an inability to produce high torque for longer durations which severely limits their lifespan.

The dual covers cause running/circular imbalance, entrapment of heat and additional stresses on the electrical motor. The dual covers are difficult to manufacture and require further expertise to align them with the motor. Further, existing electrical motors fail to produce such high values of torque without gears.

Furthermore, to produce such high values of torque without gears requires the diameter of motor to be increased to a very high value such as 400 mm. When such a large diameter is required, using conventional techniques of fabrication and using dual covers and bearings introduce all the limitations discussed above. Therefore, it becomes a futile so task to stick with conventional ways of fabricating a gearless brushless motor for HVLS fans.

Also, manufacturing of large covers is difficult to achieve, as it becomes difficult to maintain the required run-out to satisfy customer requirements. Also, such covers require large bearings adding more complexity during the assembly process and further adding additional costs in material, labor and aftermarket expenses.

Further existing electric motors used for HVLS fans allow attachment of blades to a hub. The hub is either attached to a shaft of an induction motor gear assembly or to a housing which contains a motor without gears. Such attachment requires additional parts and adding more inefficiency and complexity to the operation and maintenance of the HVLS fan.

Herein inefficiency and complexity refer to more power consumption to operate HVLS fans. Further, the additional parts also raise safety issues during operation of the electric motor. Safety issues such as unfastening of hardware, increase in sound levels, damage to bearings due to increased weight and imbalance etc cannot be avoided.

Therefore, there is a need of a brushless gearless electric motor configured to provide high torque in an HVLS electric fan. Further, the electric motor should be configured to achieve low temperature rise and complete tolerance of imbalance without damage to bearings. Furthermore, the electric motor should be configured with an axle performing multiple operations. The axle should be capable of being rotary or stationary, depending upon the speed of the rotor.

### SUMMARY OF THE INVENTION

In accordance with teachings of present invention, a brushless gearless electric motor for providing low cogging and high torque in an electric fan is provided.

An object of the present invention is to provide a brushless gearless electric motor configured to accommodate plurality of fan blades. The brushless gearless electric motor includes a rotor, a stator, an axle, a bearing and a frame structure.

The rotor rotates about an axis. Further, the rotor receives the plurality of fan blades. The stator is operable to rotate the rotor. The stator includes a bottom surface and a top surface. The rotor is configured to cover the bottom surface of the stator such that the top surface of the stator remains open to reduce overall weight.

The axle aligns the stator with the rotor. The axle centers the rotor. The bearing is positioned around the center of the axle to facilitate relative motion between the stator and the rotor. The frame structure is configured on the top surface of the stator to facilitate attachment to a ceiling.

Another object of the present invention is to provide the axle including a flange and a rod extending from the flange. The electric motor further includes a jam nut positioned below the bearing and further the jam nut pressurizes the bearing against the flange.

Another object of the present invention is to provide the electric motor with a lock nut positioned below the jam nut. Further, the lock nut sandwiches the bearing between the flange and the jam nut. Further the brushless gearless electric motor wherein the open top surface facilitates scalability by facilitating different heights of the stator in the same rotor configuration.

Another object of the present invention is to provide the rotor with an inner surface and an outer surface. Further, the electric motor includes a plurality of dimples configured on the inner surface of the rotor. The dimples agitate air and liquid inside the rotor.

Another object of the present invention is to provide the electric motor with a machine controller programmed to control the voltage supply to the stator. Further, the machine controller is capable of interfacing with a single of three phase power supply.

These and other features and advantages will become apparent from the following detailed description of illustrative embodiments thereof, which is to be read in connection with the accompanying drawings.

### BRIEF DESCRIPTION OF DRAWINGS

FIG. 1 illustrates an exploded view of a brushless gearless electric motor configured to accommodate a plurality of fan blades in accordance with a preferred embodiment of the present invention;

FIG. 2 illustrates a front cross-sectional view of the brushless gearless electric motor in accordance with another preferred embodiment of the present invention;

FIG. 3 illustrates a front cross-section view of the axle, bearing, lock nut and jam nut in accordance with another preferred embodiment of the present invention;

FIG. 4 illustrates a perspective view of brushless gearless electric motor attached to a windmill in accordance with an exemplary embodiment of the present invention; and

FIG. 5 illustrates a perspective view of brushless gearless electric motor attached to a vehicle in accordance with another exemplary embodiment of the present invention.

### DETAILED DESCRIPTION OF DRAWINGS

While this technology is illustrated and described in a preferred embodiment, a brushless gearless electric motor configured to accommodate a plurality of fan blades may be produced in many different shapes, sizes, materials, forms and configurations. This is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

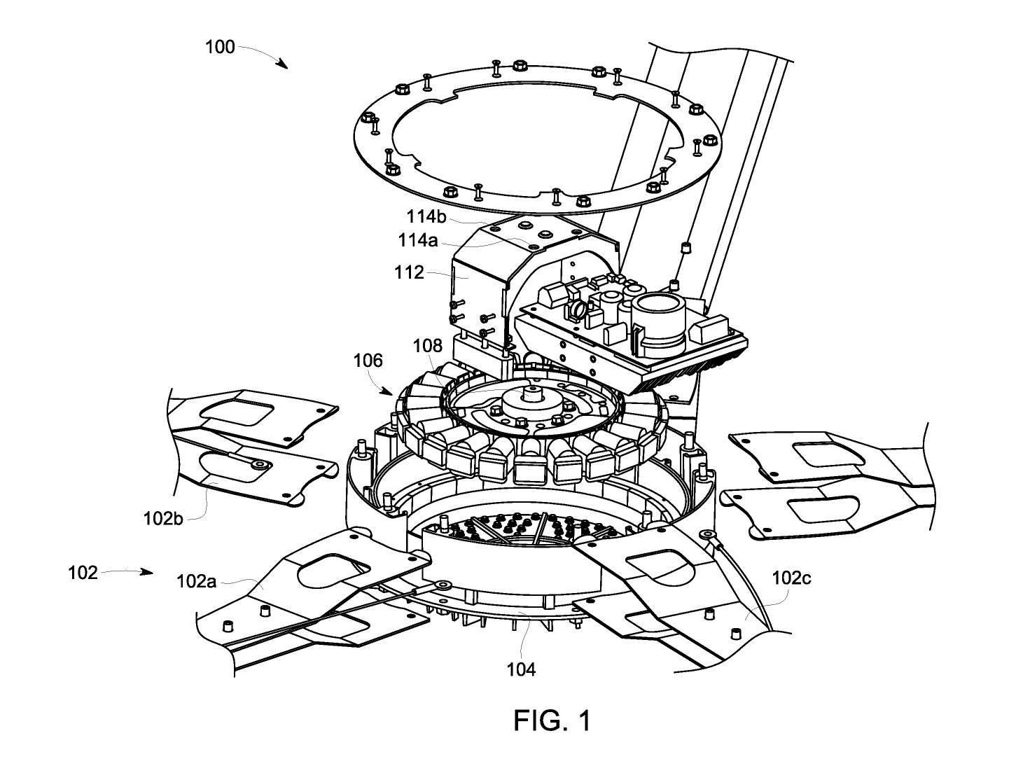

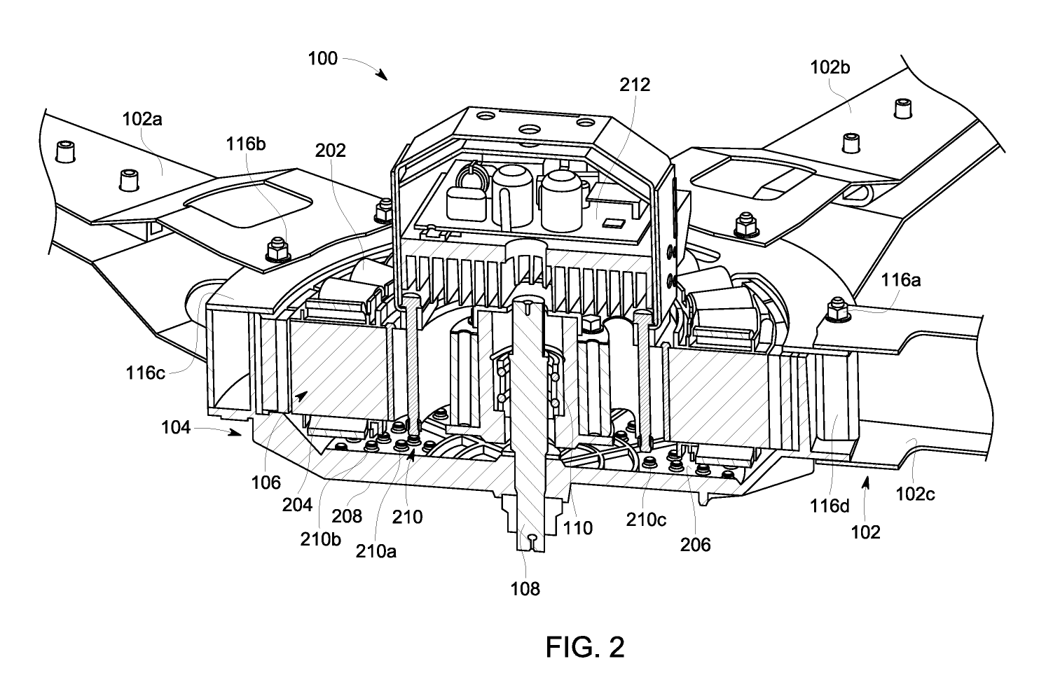

FIG. 1 illustrates an exploded view of a brushless gearless electric motor 100 configured to accommodate a plurality of fan blades 102, such as 102a, 102b, 102c in accordance with a preferred embodiment of the present invention. The brushless gearless electric motor 100 includes a rotor 104, a stator 106, an axle 108, a bearing (110, shown in FIG. 2), and a frame structure 112.

The rotor 104 rotates about an axis. Further, the rotor 104 receives a plurality of fan blades 102. The stator 106 is operable to rotate the rotor 104. The stator 106 includes a top surface and a bottom surface. The rotor 104 is configured to cover the bottom surface of the stator 106 such that the top surface of the stator 106 remains open to reduce overall weight.

The stator 106 and the bearing (110, shown in FIG. 2) are explained in detail in conjunction with FIG. 2 of the present invention. The frame structure 112 is configured on the top surface of the stator 106 to facilitate attachment to a fixed support. In another preferred embodiment of the present invention, the frame structure 112 includes one or more indents 114a, 114b.

The one or more indents 114a, 114b receive screws and bolts to attach the frame structure 112 with the fixed support. It would be readily apparent to those skilled in the art that the frame structure 112 may be attached to any fixed support such as a ceiling, appliance (vehicle, windmill, belt driven machinery, etc), wall, floor or any immovable body without deviating from the scope of the present invention. Preferably, the frame structure 112 allows either direct attachment to the fixed support or receives a stem to attach indirectly with the fixed support.

FIG. 2 illustrates a front cross-sectional view of the brushless gearless electric motor 100 in accordance with another preferred embodiment of the present invention. The bearing 110 is positioned around the center of the axle 108 to facilitate relative motion between the stator 106 and the rotor 104. Further, the bearing 110 allows relative motion between the axle 108 and the stator 106.

Examples of bearing 110 include but not limited to Bearings such as SKF 6208-22, or Bearing Timkin 516007. Preferably, the diameter of the bearing 110 ranges between 50 mm to 100 mm and the height ranges between 15 mm to 40 mm.

The stator 106 includes a top surface 202 and a bottom surface 204. The rotor 104 covers the bottom surface 204 of the stator 106 such that the top surface 202 of the stator 106 remains open to reduce overall weight. The open top surface 202 eliminates the need of another load bearing cover.

In another preferred embodiment of the present invention, the open top surface 202 facilitates scalability by facilitating different dimensions of the stator 106 in the same rotor 104 configuration. The scalability herein refers to allow various numbers and various diameters of fan blades 102a, 102b and 102c to attach with the rotor 104.

The scalability further allows configuration of various sizes of stator 106 and thus allowing several motor platforms of different ratings in terms of torque and power to be generated in the same rotor 104. The size variation of the stator 106 depends upon the stack height or diameter of the stator 106.

Further, the open top surface 202 manages to reduce extra elements such as an additional load bearing rotor cover for covering the open top surface 202, bearings, screws, bolts and similar additional hardware etc. Thus, the brushless gearless electric motor 100 results in elimination of all the issues of conventional electric motors discussed in the description of related art of the present specification.

In another preferred embodiment of the present invention, the rotor 104 includes an inner surface 206 and an outer surface 208. The brushless gearless electric motor 100 includes a plurality of dimples 210 such as 210a, 210b and 210c which are configured on the inner surface 206 of the rotor 104.

The dimples 210 agitate air and liquid inside the rotor 104. The cooling liquid is poured in the rotor 104. The dimples 210 help in agitating the liquid to enhance the rotor 104 ability to cool the stator 106. The dimples 210 protrude from the inner surface 208 of the rotor that agitates air and the cooling liquid poured inside the rotor 104.

In another preferred embodiment of the present invention, the brushless gearless electric motor 100 includes a plurality of fan blade retention units such as 116a, 116b, 116c and 116d configured on the outer surface of the rotor 104 to receive fan blades 102a, 102b, and 102c respectively.

An example of fan blade retention units 116a, 116b 116c, 116d includes but not limited to nuts and bolts; and 116c is a plate surrounding the stator 106 and the rotor 104 to receive fan blades 102 and the nuts and bolts 116a, 116b are used to join the fan blades 102 on the plate 116c; and 116d is a blade spacer is sandwiched between the rotor 104 and the plate 116c. The blade spacer 116d stabilizes the fan blades 102.

It would be readily apparent to those skilled in the art that various fan blade retention units 116a, 116b,116c and 116d for attaching fan blades 102 to the rotor 104 may be envisioned without deviating from the scope of the present invention.

In another preferred embodiment of the present invention, the brushless gearless electric motor 100 includes a motor drive unit 212 embedded in the frame structure capable of controlling the voltage supplied to the stator 106. Generally, the motor drive unit 212 includes printed circuit boards, machine controller, heat sink, resistors, capacitors, semiconductors components, semiconductor power switches, conductors, fuses, relays, connectors, and micro-controllers etc. The microcontroller is programmed to activate semi-conductor switches to control the rotation of the rotor 104.

Further, the micro-controller monitors current flowing through the windings, the temperature of the interior of the rotor 104 through some of the semiconductor components, supply voltage applied to the rotor 104 and receives commands wirelessly or through a wired communication interface.

In another preferred embodiment of the present invention, the brushless gearless electric motor 100 further includes a top cover (not shown in FIG. 2) for protecting the stator 106 and parts surrounding stator 106 such as retention units such as 116a, 116b, 116c. Examples of top cover includes but not limited to a plastic cover, thin metal cover, perforated covers, and other similar lightweight covers to protect from dust and water. The top cover does not have any ability to carry rotational load.

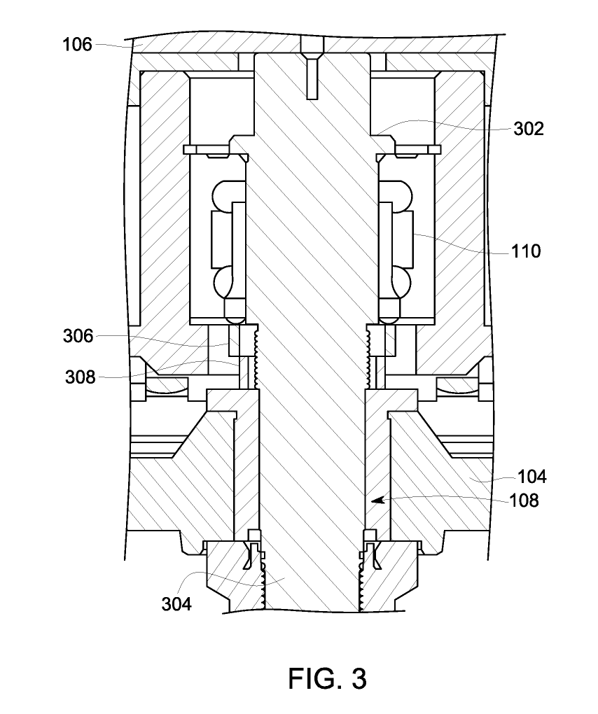

FIG. 3 illustrates a front cross-section view of the axle 108 to display position of the bearing 110 in accordance with another preferred embodiment of the present invention. The axle 108 includes a flange 302 and a rod 304 extending from the flange 302 towards the rotor 104.

The bearing 110 is positioned below the flange 302 and on the center of the axle 108. The bearing 110 facilitates relative motion between the stator 106 and the axle 108. In another preferred embodiment of the present invention, the brushless gearless electric motor 100 includes a jam nut 306 and a lock nut 308.

The jam nut 306 is positioned below the bearing 110. The jam nut 306 pressurizes the bearing 110 against the flange 302. The lock nut 308 is positioned below the jam nut 306. The lock nut sandwiches the bearing 110 in between the flange 302 and the jam nut 306.

The jam nut 306 pressurizes the bearing 110 to hold its location on the axle 108. The lock nut 308 pressurizes the jam nut 306 to hold its location to apply double pressure on the bearing 110 to hold its location.

The jam nut 306 and the lock nut 308 secure the position of the bearing 110 and avoiding any slipping of the bearing 110 on the axle 108.

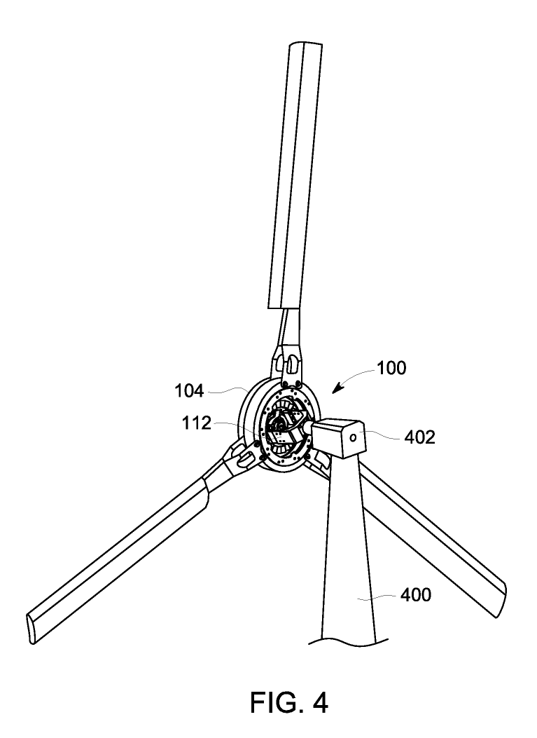

FIG. 4 illustrates a perspective view of brushless gearless electric motor 100 attached to a windmill 400 in accordance with an exemplary embodiment of the present invention. The brushless gearless electric motor 100 is able to receive the plurality of fan blades of the windmill 400. The windmill 400 fan blades are connected to the rotor 104. The rotor 104 covers only the bottom surface of the stator and the top surface remain open as visible in the FIG. 4. The frame structure 112 attaches to the shaft 402 of the windmill 400.

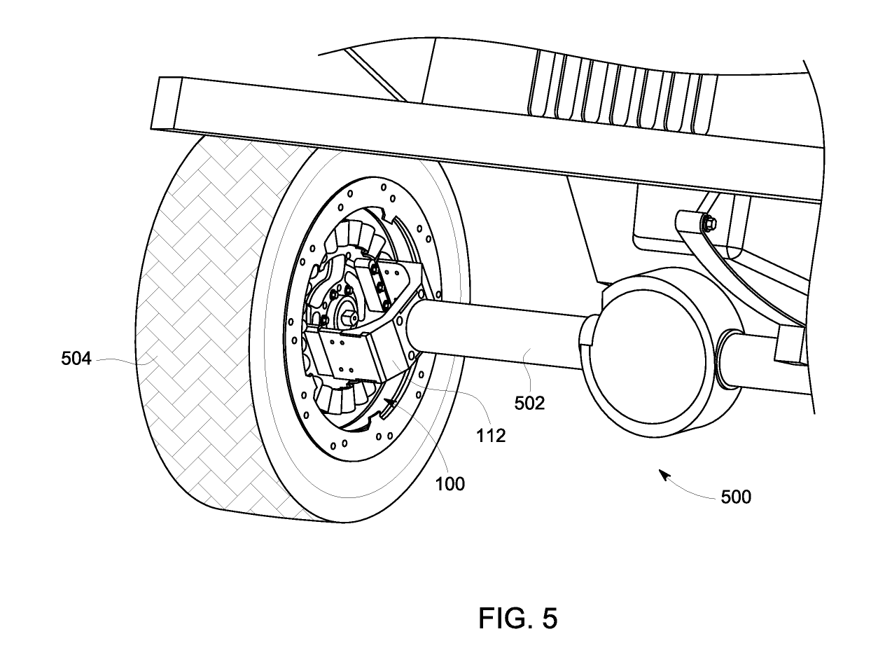

FIG. 5 illustrates a perspective view of brushless gearless electric motor 100 attached to a vehicle 500 in accordance with another exemplary embodiment of the present invention. The frame structure 112 attaches to the mechanical frame 502 (such as axle) of the vehicle 500. The rotor (not shown in FIG. 5) covers the bottom surface and the top surface remain open as visible in FIG. 5. The brushless gearless electric motor 100 is located within each tire 504 of the vehicle 500.

The present invention offers various advantages such as immensely high torque, reduced weight, and low heating of electric motor for HVLS fans and several other applications. Further, the present invention provides the brushless gearless electric motor with high reliability, a single bearing design and reduced part count such as no top cover for the rotor to cover the top surface of the stator. Further, the present invention provides electric motor used in HVLS fans for moving air in large buildings. Furthermore, the present invention is able to function with various appliances such as windmill, vehicle tires etc.

Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A brushless gearless electric motor configured to accommodate a plurality of fan blades, the brushless gearless electric motor comprising:
a rotor to rotate about an axis, further the rotor receives the plurality of fan blades;
a stator operable to rotate the rotor, the stator having a bottom surface and a top surface, wherein the rotor configured to cover the bottom surface of the stator such that the top surface of the stator remains open to reduce overall weight;
an axle to align the stator with the rotor, further the axle centers the rotor;
a bearing positioned around the center of the axle to facilitate relative motion between the stator and the rotor; and
a frame structure configured on the top surface of the stator to facilitate attachment to a fixed support.

2. The brushless gearless electric motor according to claim 1 wherein the axle further comprising: a flange; and a rod extending from the flange towards the rotor.

3. The brushless gearless electric motor according to claim 2 further comprising a jam nut positioned below the bearing, further the jam nut pressurizes the bearing against the flange.

4. The brushless gearless electric motor according to claim 3 further comprising a lock nut positioned below the jam nut, further the lock nut sandwiches the bearing in between the flange and the jam nut.

5. The brushless gearless electric motor according to claim 1 wherein the open top surface facilitates scalability by accommodating different dimensions of the stator in the same rotor configuration.

6. The brushless gearless electric motor according to claim 1 wherein the rotor comprising an inner surface and an outer surface.

7. The brushless gearless electric motor according to claim 6 further comprising plurality of dimples configured on the inner surface of the rotor, wherein the dimples agitate air and liquid inside the rotor.

8. The brushless gearless electric motor according to claim 1 further comprising a motor drive unit embedded in the frame structure programmed to control the voltage supply to the stator.

9. The brushless gearless electric motor according to claim 1 further comprising a top cover to protect the stator and parts surrounding the stator from water and dust.

10. The brushless gearless electric motor according to claim 6 further comprising fan blade retention units configured on the outer surface of the rotor to receive fan blades.

11. A brushless gearless electric motor configured to attach with a mechanical frame of an appliance, the brushless gearless electric motor comprising:
a rotor rotates about an axis;
a stator operable to rotate the rotor, the stator having a bottom surface and a top surface, wherein the rotor configured to cover the bottom surface of the stator such that the top surface of the stator remains open to reduce overall weight;
an axle to align the stator with the rotor, further the axle centers the rotor;
a bearing positioned around the center of the axle to facilitate relative motion between the stator and the rotor; and
a frame structure configured on the top surface of the stator to facilitate attachment to the mechanical frame.

12. The brushless gearless electric motor according to claim 11 wherein the axle further comprising: a flange; and a rod extending from the flange towards the rotor.

13. The brushless gearless electric motor according to claim 12 further comprising a jam nut positioned below the bearing, further the jam nut pressurizes the bearing against the flange.

14. The brushless gearless electric motor according to claim 13 further comprising a lock nut positioned below the jam nut, further the lock nut sandwiches the bearing in between the flange and the jam nut.

15. The brushless gearless electric motor according to claim 11 wherein the open top surface facilitates scalability by accommodating different dimensions of the stator in the same rotor configuration.

16. The brushless gearless electric motor according to claim 11 wherein the rotor comprising an inner surface and an outer surface.

17. The brushless gearless electric motor according to claim 16 further comprising plurality of dimples configured on the inner surface of the rotor, wherein the dimples agitate air and liquid inside the rotor.

18. The brushless gearless electric motor according to claim 11 further comprising a motor drive unit embedded in the frame structure programmed to control the voltage supply to the stator.

19. The brushless gearless electric motor according to claim 11 further comprising a top cover protects the stator and parts surrounding the stator from water and dust.
